(19) United States
(12) Patent Application Publication
(10) Pub. No.: US 2015/0179293 A1
(43) Pub. Date: Jun. 25, 2015

(54) X-RAY DEVICE AND X-RAY MEASUREMENT METHOD

(71) Applicant: CANON KABUSHIKI KAISHA, Tokyo (JP)

(72) Inventor: Taihei Mukaide, Yokohama-shi (JP)

(21) Appl. No.: 14/405,753

(22) PCT Filed: May 21, 2013
(86) PCT No.: PCT/JP2013/064566

§ 371 Date: Dec. 4, 2014

(30) Foreign Application Priority Data
Jun. 7, 2012 (JP) 2012-130103

(51) Int. Cl. G21K 5/04; G21K 1/10; G01N 23/203

(52) U.S. Cl. CPC G21K 5/04; G01N 23/203; G21K 1/10; G21K 2207/005

(57) ABSTRACT

The present invention provides an X-ray device and an X-ray measurement method which can acquire a scattering contrast image of an object.

The X-ray device includes a detector including a first pixel and a second pixel and an attenuation element which is provided on the second pixel and attenuates intensity of an X-ray beam. The X-ray device also includes an arithmetic device that calculates a pixel value of a scattering contrast of the object from detection intensity of the X-ray beam detected by the first pixel and detection intensity of the X-ray beam detected by the second pixel.

### TECHNICAL FIELD

The present invention relates to an X-ray device using X-ray and an X-ray measurement method.

### BACKGROUND ART

Non-destructive examination using radiation is used in a wide range of fields from an industrial use to a medical use. For example, an X-ray, which is one of radial rays, is an electromagnetic wave with a wavelength of about 10⁻¹² to 10⁻⁸ m and an X-ray with high energy (about 2 keV to 100 keV) is called a hard X-ray. An X-ray with low energy (about 0.1 keV to 2 keV) is called a soft X-ray.

An absorption contrast method that uses difference of X-ray absorption ability is practically used in a security field such as internal crack inspection of steel material and baggage inspection.

On the other hand, an X-ray phase contrast method that detects phase change of X-ray by an object is effective for an object where contrast is difficult to be generated by absorption of X-ray (for example, a low density object). A method that uses such X-ray phase contrast imaging is studied to be applied to imaging of a phase separation structure of high polymer material, medical procedure, and the like.

PTL 1 discloses an X-ray imaging device in which a mask that blocks X-rays is placed on an edge portion of pixels of a detector.

FIGS. 12A and 12B illustrate enlarged views around the detector in PTL 1. FIG. 12A is a top view of the detector seen from the incident direction of the X-ray and FIG. 12B is a side view of the detector seen from a direction perpendicular to the incident direction of the X-ray.

In FIGS. 12A and 12B, a blocking element 1302 for blocking the X-ray is provided on an edge portion (boundary portion with an adjacent pixel) of a pixel 1301 (detection element) of the detector. An incident X-ray 1303 is incident on each pixel so that the incident X-ray 1303 is incident on a part of the blocking element 1302. When the X-ray is incident on an object in an arrangement as described above, the position of the incident X-ray 1303 on the detection pixel 1301 is changed by a refraction effect. The amount of X-ray blocked by the blocking element 1302 changes due to the position change, so that it is possible to measure information of the X-ray refracted by the object and further information of the X-ray absorbed by the object is also measured in parallel with the information of the X-ray refracted by the object.

However, the method described in PTL 1 cannot separately extract the information of the X-ray absorbed by the object and information of the X-ray scattered by the object from acquired data. When the object is formed of an aggregate of microparticles or the like, the X-ray 1303 is spread by the effect of scattering and the detection pixel 1301 detects change of intensity of the X-ray caused by the scattering of the X-ray. However, the absorption of the X-ray by the object also generates the change of intensity. Therefore, the method described in PTL 1 cannot determine whether the change of intensity is caused by the absorption of the object or the scattering of the X-ray.

### CITATION LIST

### Patent Literature

PTL 1 International Publication No. 2008/029107 pamphlet

### SUMMARY OF INVENTION

Therefore, the present invention provides an X-ray device and an X-ray measurement method which can acquire the information of the scattering of the X-ray separate from the information of the absorption of the X-ray.

The X-ray device includes a detector including a first pixel and a second pixel different from the first pixel, which are configured to detect intensity of an X-ray beam passing through an object, an attenuation element configured to attenuate an X-ray beam which is a part of the X-ray beam passing through the object and incident on the second pixel, and an arithmetic device configured to acquire information of the object including scattering information of the object from detection intensity of the X-ray beam detected by the first pixel and detection intensity of the X-ray beam detected by the second pixel. When the object is not located in an optical path of the X-ray beam, the X-ray beam is irradiated on a boundary between the first pixel and the second pixel.

Other aspects of the present invention will be described in embodiments.

### BRIEF DESCRIPTION OF DRAWINGS

FIG. 1 is a diagram illustrating a device configuration according to a first embodiment.

FIG. 2 is a diagram illustrating variation of an X-ray beam intensity profile.

FIG. 3 is a diagram illustrating a relationship between an X-ray beam, an attenuation element, and a detector according to the first embodiment.

FIGS. 4A and 4B are diagrams illustrating variation of the X-ray beam intensity profile when the X-ray beam is scattered.

FIG. 5 is a diagram illustrating a relationship of v with respect to Δx.

FIG. 6 is a diagram illustrating a relationship of v′ with respect to Δx.

FIG. 7 is a diagram illustrating a device configuration according to a second embodiment.

FIG. 8 is a diagram illustrating the device configuration according to the second embodiment.

FIG. 9 is a diagram illustrating a device configuration according to a third embodiment.

FIG. 10 is a diagram illustrating a device configuration according to the third embodiment.

FIG. 11 is a diagram illustrating a relationship between an X-ray beam and an attenuation element according to an example.

FIGS. 12A and 12B are diagrams illustrating a region around a detector according to PTL 1.

### DESCRIPTION OF EMBODIMENTS

In embodiments of the present invention, a detection result, by which object information including information of phase change and information of scattering of X-ray caused by the object can be acquired, is obtained by using an X-ray beam and a detector. The information of phase change of X-ray caused by the object is referred to as phase information of the object and the information of scattering of X-ray caused by the object is referred to as scattering information of the object. An X-ray device of the embodiments further includes an arithmetic device and can acquire information of the object including the phase information of the object and the scattering information of the object from the detection result of the detector. The information of the object including the phase information of the object and the scattering information of the object may be referred to as simply the scattering information of the object.

When the object is not located in an optical path of the X-ray beam, the X-ray beam can be detected by both first and second pixels. The X-ray irradiated to the second pixel is irradiated to the second pixel after passing through an attenuation element. As the attenuation element, an attenuation element is arranged which changes the intensity of the X-ray according to the amount of change of an irradiation position of the X-ray irradiated to the second pixel. The arithmetic device acquires the information of the object including both the phase information and the scattering information from intensity information of the first pixel and the second pixel. When the information is imaged, an image including the phase information and the scattering information can be acquired. The arithmetic device is configured to be able to acquire absorption contrast. Hereinafter, specific embodiments will be described.

### First Embodiment

In a first embodiment, an X-ray device and an X-ray measurement method which use one X-ray beam will be described.

### Basic Configuration of Device

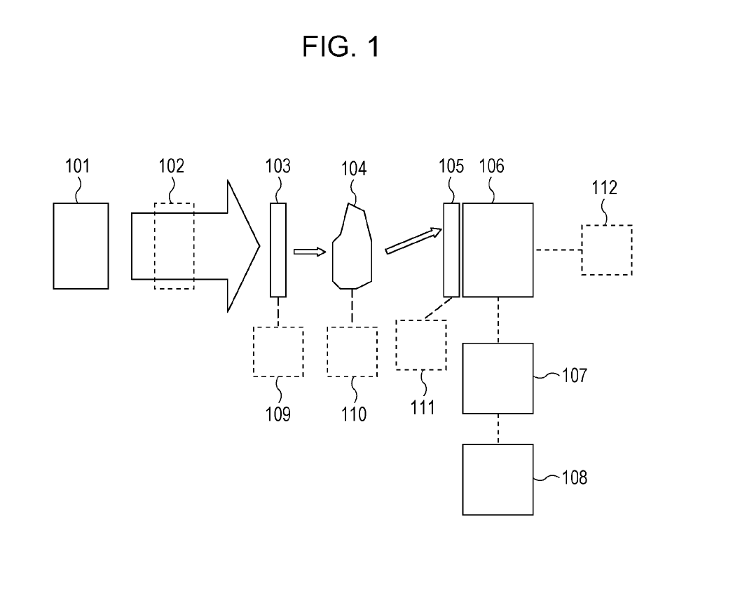

FIG. 1 shows a configuration diagram of an X-ray device according to the present embodiment.

An X-ray generated from an X-ray source 101, which is an X-ray generation unit, is formed into an X-ray beam by an aperture 103.

As the aperture 103, for example, an aperture having a slit shape that can form a line-shaped X-ray beam or having a pin hole shape that can form a point-shaped X-ray beam. The slit and the pin hole may penetrate a substrate or need not penetrate the substrate. When the slit and the pin hole do not penetrate the substrate, a filter material for X-ray may be used as a substrate of a splitting element. A material that forms the aperture 103 is selected from Pt, Au, Pb, Ta, W, and the like which have a high absorption rate of X-ray. Or, the material may be a compound including these materials.

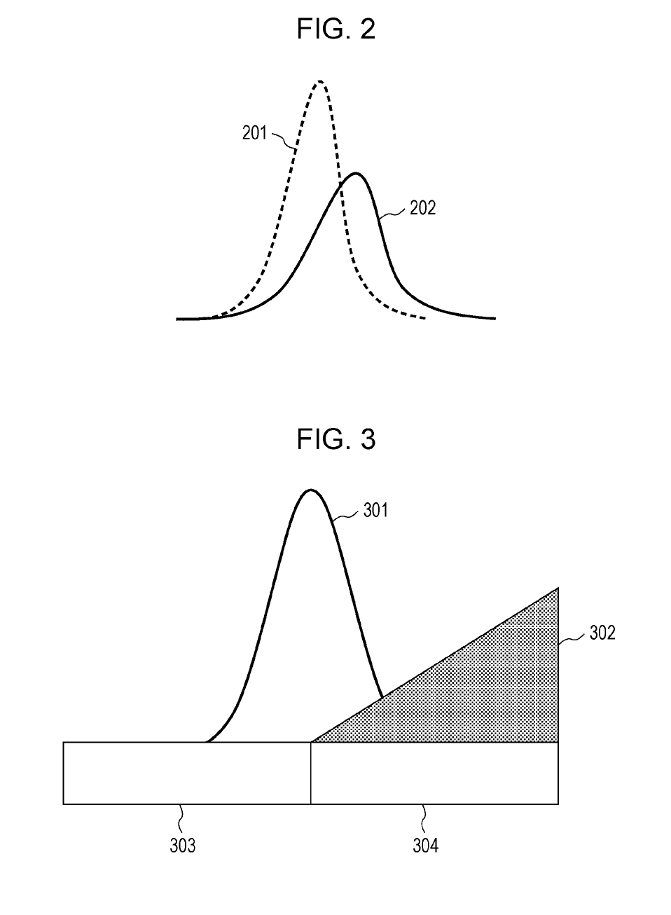

FIG. 2 shows a schematic diagram of an intensity profile (intensity distribution) of the X-ray beam passing through an object 104 and shows that the higher the peak (the upper in the diagram), the more intense the X-ray is. An X-ray beam 201 is an intensity profile when the object 104 is not located in an optical path of the X-ray beam. An X-ray beam 202 is an intensity profile when the object 104 is located in the optical path of the X-ray beam. The X-ray is absorbed by the object 104, so that the intensity of the X-ray beam decreases. Further, the phase of the X-ray is changed by the object 104 and the X-ray is refracted, so that the position of the X-ray beam is shifted. Furthermore, the intensity profile becomes broad due to the effects of the scattering of the X-ray caused by the object 104.

The X-ray beam passing through the object 104 is irradiated to an attenuation element 105 and the intensity of the X-ray is detected by a detector 106. The detected intensity information is arithmetically processed by an arithmetic device 107 and outputted to a display unit 108 such as a monitor.

Examples of the object 104 include an inorganic material and an inorganic-organic composite material in addition to a human body.

Moving units 109, 110, 111, and 112 such as stepping motors which relatively move the aperture 103, the object 104, the attenuation element 105, and the detector 106 may be provided. For example, if measurement is performed while the object 104 is being moved by the moving unit 110, the entire image of the object 104 can be obtained.

As the detector 106, various two-dimensional X-ray detectors can be used whether the X-ray detector is an indirect conversion type or a direct conversion type. For example, the detector 106 is selected from an X-ray CCD camera, an indirect conversion type flat panel detector, a direct conversion type flat panel detector, and the like. Also, a discrete type photodiode may be used.

When a monochromatic X-ray is used, a monochromatizing unit 102 may be disposed between the X-ray source 101 and the aperture 103. As the monochromatizing unit 102, a monochromator or an X-ray multilayer mirror combined with a slit may be used.

### Relationship Between X-Ray Beam, Attenuation Element, and Detector

Next, a relationship between the X-ray beam, the attenuation element, and the detector according to the present embodiment will be described with reference to FIG. 3.

An X-ray beam 301 represents an X-ray beam when the object 104 is not located in the optical path of the X-ray beam. The X-ray beam 301 is irradiated to a first pixel 303 and a second pixel 304. An attenuation element 302 is arranged on the second pixel 304. When the object 104 is not located in an optical path of the X-ray beam 301, the center of the intensity of the X-ray beam 301 (the center of gravity of the X-ray beam) is set to be located on a boundary between the first pixel 303 and the second pixel 304.

Although the first pixel 303 and the second pixel 304 are arranged adjacent to each other in FIG. 3, the first pixel 303 and the second pixel 304 are determined according to areas used when an arithmetic operation is performed. For example, four pixels of eight pixels may be determined to be the first pixels 303 and the remaining four pixels may be determined to be the second pixels 304.

The attenuation element 302 is formed into a wedge shape (triangular prism) and has an absorption ability slope where the amount of absorption (the amount of transmission) of X-ray varies along a direction in which the irradiation position is changed by the refraction of the X-ray beam caused by the object. Here, the attenuation element 302 is formed so that the farther away from the boundary between the first pixel 303 and the second pixel 304 in the direction toward the second pixel, the larger the amount of absorption of X-ray.

The absorption ability slope of the attenuation element 302 need not necessarily be continuous, but the amount of absorption (the amount of transmission) may change in a staircase pattern (in a step shape). For example, the shape of the absorption ability slope may change in incremental steps. In the present description, the step shape is also represented as “continuous”. However, it is preferable that there are two or more steps (there are a region a1, a region a2, and a region a3 of the absorption ability). Not only the attenuation element 302 in which the thickness of the element continuously changes, but also the attenuation element 302 in which the density of the element continuously changes may be used.

The X-ray beam that enters the second pixel 304 enters the second pixel 304 after passing through the attenuation element 302. The second pixel 304 and the attenuation element are arranged such that the X-ray beam enters the second pixel 304 after passing through the attenuation element 302. In the description of the present application, the arrangement described above is referred to as “the attenuation element is arranged on the second pixel”.

To arrange the attenuation element on the second pixel, for example, the attenuation element may be arranged on the upper side of the second pixel. Here, the upstream side of the X-ray (the side of the X-ray source) is defined as the upper side.

In FIG. 3, the attenuation element 302 is arranged to be in contact with the second pixel 304. However, the attenuation element 302 and the second pixel 304 may be arranged to be apart from each other. As a result, in the description of the present application, even when the attenuation element 302 and the second pixel 304 are not in contact with each other, an expression “is arranged on the” is used.

When the incident position of the X-ray beam 301 changes, the detection intensities of the first pixel 303 and the second pixel 304 also change. Here, the attenuation element 302 is not arranged on the first pixel 303, but the attenuation element 302 is arranged on the second pixel 304, so that the amount of change of the detection intensity with respect to the position change of the X-ray beam is different between the first pixel 303 and the second pixel 304. Therefore, the amount of position change of the X-ray beam can be estimated on the basis of an index that can determine a difference between the amount of change of the detection intensity of the first pixel 303 and the amount of change of the detection intensity of the second pixel 304.

For example, when the intensity of the first pixel 303 is I₁ and the intensity of the second pixel 304 is I₂, it is possible to estimate the amount of position change of the center of gravity of the X-ray beam by using a value v indicated in the formula (1).

$$v = \frac{{I}_{1} - {I}_{2}}{{I}_{1} + {I}_{2}} \qquad [ Math . 1 ]$$

Here, in order to cancel the effect of the absorption, the difference between I₁ and I₂ is divided by the sum of I₁ and I₂. Hereinafter, the position change of the center of gravity of the X-ray beam may be referred to as simply the position change of the X-ray beam.

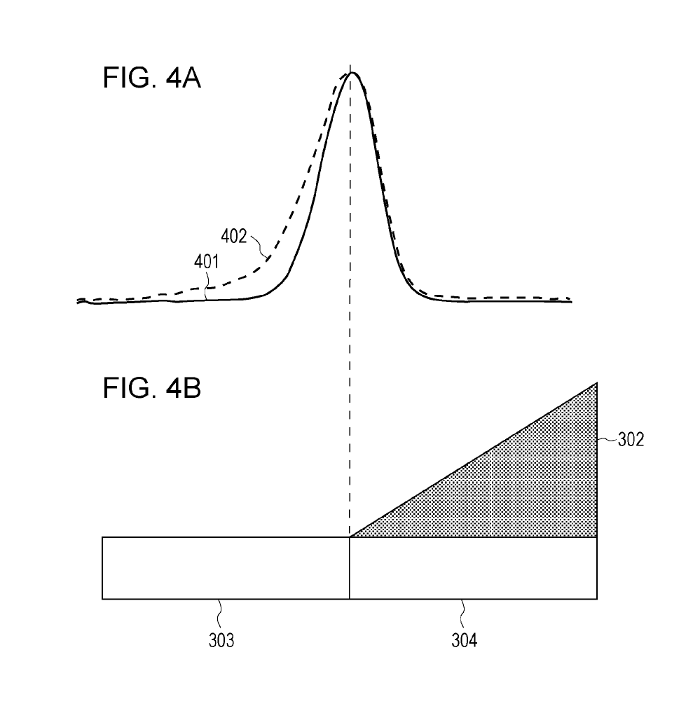

FIG. 4A shows an intensity profile of the X-ray that enters the detector. In FIG. 4B, a plurality of pixels 303 and 304 described in FIG. 3 and the attenuation element 302 are illustrated. These are illustrated to correspond to the intensity profile in FIG. 4A.

In FIG. 4A, the intensity profile 401 (solid line) is an intensity profile of the X-ray that enters the detector when the object is not located in the optical path. The intensity profile 402 (dashed line) is an intensity profile of the X-ray that enters the detector when the X-ray is scattered by the object. Although the intensity is attenuated by absorption in an actual measurement, a normalized intensity profile is shown for explanation in FIG. 4A.

In a region of the first pixel 303 where the attenuation element 302 is not located, the intensity profile 402 is more broadened than the intensity profile 401 by the effects of scattering. On the other hand, in a region of the second pixel 304 where the attenuation element 302 is located, although there are the effects of scattering, the sensitivity to the change of the intensity is reduced by the attenuation element 302. Therefore, in the region of the second pixel 304, the profile is less broadened than that in the region of the first pixel 303. In other words, the change of the detection intensity of the scattering is different between the area where the attenuation element 302 is located and the area where the attenuation element 302 is not located.

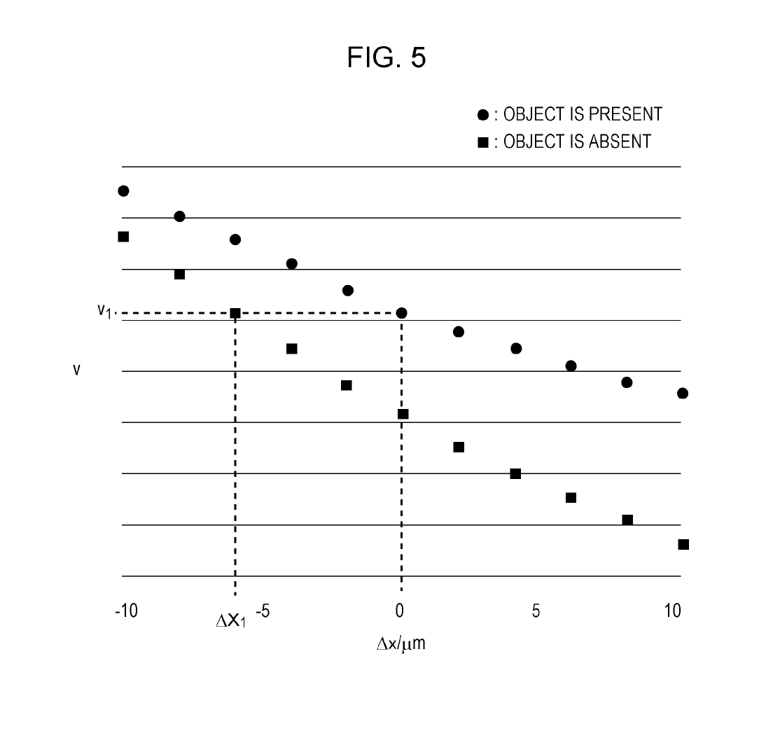

FIG. 5 shows a relationship of v with respect to the amount of position change of the X-ray beam (Δx). Here, the plots represented by the black squares are data obtained by moving the X-ray beam with respect to the detector 106 when a certain object (known sample) is not located in the optical path of the X-ray beam. The plots represented by the black circles are data obtained by locating the certain object (known sample) in the optical path. Specifically, the plots represented by the black squares simply represent a correspondence relationship between the position of the center of gravity of the X-ray beam and v and the plots represented by the black circles represent a correspondence relationship between the intensity profile of the X-ray beam affected by the refraction and scattering caused by the object and v.

As understood from FIG. 5, both data have different values of v even when the amount of position change of the X-ray beam (Δx) is the same. Therefore, v includes not only the phase information, but also the scattering information. As a result, it is possible to acquire an image including the phase information and the scattering information by acquiring v by using a detection result of the detector and imaging the information. When Δx obtained from v is imaged, it is also possible to acquire an image including the phase information and the scattering information.

A more detailed description will be given with reference to FIG. 5. When the position of the X-ray beam is not changed in the case without the refraction of the X-ray caused by the object, that is, when Δx is 0, v should be v₁.

However, the actual data is an unknown sample. Therefore, even if a value of v=v₁ is obtained as an experimental result of an unknown sample, the value can be substituted into only a relational expression (plots represented by the black squares) acquired from the data obtained by not locating the object. Therefore, if Δx is obtained by using the plots (black squares) of the data obtained by not locating the object, when v is v₁, Δx is Δx₁.

In other words, although a true amount of position change (Δx) of the X-ray beam passing through a certain region is 0, when the amount of position change of the X-ray is acquired by using the data obtained by not locating the object, Δx is Δx₁. When the amount of position change is converted into an image, due to a difference between a true amount of position change (here, 0) and an acquired amount of position change (here, Δx₁), a contrast is formed between a region including scattering and a region not including scattering even when the amount of refraction of the X-ray beam is the same.

The above phenomenon will be described from another point of view with reference to FIGS. 4A and 4B. In FIG. 4A, the profile 401 (solid line) is a profile when the object is not located in the optical path. The profile 402 (dashed line) is a profile when the object is located in the optical path. As illustrated in FIG. 4A, the profile 401 detected in a region where the attenuation element 302 is not provided has less effect of scattering than the profile 402 detected in a region where the attenuation element 302 is provided. Therefore, since the change of the detection intensity caused by the effects of the scattering is different between the first pixel 303 and the second pixel 304, it is possible to obtain the scattering information by comparing the detection intensity of the first pixel 303 and the detection intensity of the second pixel 304.

Although the value of v may be directly outputted as the contrast of the images, in this case, if the position of the X-ray beam changes, the contrast is distorted because the relationship between v and Δx is nonlinear. Therefore, the arithmetic device 107 fits the relationship between v and Δx by a function in advance. The arithmetic device 107 calculates v from the detection intensities of each pixel detected by the detector 106 and further obtains Δx by substituting v into the fitted function. It is possible to reduce the distortion of the contrast by converting the Δx into an image.

### Other Modified Examples

In the embodiment described above, the pixel value of the output image is given from v which is an index obtained by the formula (1). However, the important point is that indexes other than v can be used if the indexes can determine the difference between the amount of change of the detection intensity of the first pixel and the amount of change of the detection intensity of the second pixel, which are caused by refraction or scattering.

In other words, any index can be used which is based on a difference, a ratio, or the like between the detection intensity of the first pixel and the detection intensity of the second pixel.

For example, the formula (1) divides the difference between I₁ and I₂ by the sum of I₁ and I₂. This is based on the difference between the detection intensity of the first pixel and the detection intensity of the second pixel. For example an index may be used in which “(I₁−I₂)²” is used instead of (I₁−I₂) in the formula (1) described above.

Similarly, the index may be an index which is based on a ratio between the detection intensity of the first pixel and the detection intensity of the second pixel. For example, the pixel value of the output image may be determined by using v′ represented by the formula (2) below.

$${v}^{′} = \frac{{I}_{1}}{{I}_{2}} \qquad [ Math . 2 ]$$

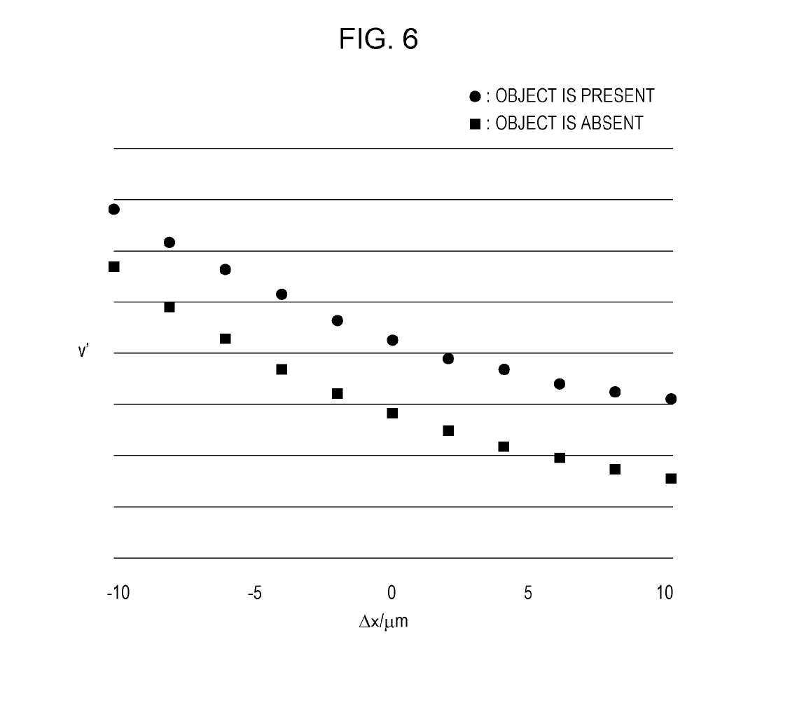

FIG. 6 shows a relationship of v′ with respect to Δx. Here, the plots represented by the black squares are data obtained by not locating a certain object (known sample) in the optical path of the X-ray beam. The plots represented by the black circles are data obtained by locating the certain object (known sample) in the optical path.

In the same manner as in FIG. 5, in FIG. 6, the value of v′ is different between the data of black squares and the data of black circles even when Δx is the same, so that an image including the phase information and the scattering information can be acquired from the relationship between v′ and Δx.

Although, in the same manner as in the case of v, v′ may be used as the pixel value of the output image, in such a case, the contrast is distorted because the relationship between v′ and Δx is nonlinear. Therefore, the relationship between v′ and Δx is fitted by a function. Then, v′ is calculated from the detection intensities of each pixel detected by the detector 106 and further Δx is obtained by substituting v′ into the fitted function. It is possible to reduce the distortion of the contrast by using the Δx as the pixel value.

The amount of position change of the X-ray beam caused by the object 104 where the phase change is small is slight, so that the nonlinear effect is small. Therefore, the value of v or v′ may be directly converted into an image.

In the above description, Δx is determined by using v, v′, or the like calculated from a measurement value when the object is located in the optical path of the X-ray beam. However, the pixel value may be determined by using an index or the like obtained by subtracting v when the object is not located from v when the object is located. Specifically, the pixel value may be determined on the basis of H of the formula (3) below.

H=(I₁−I₂)/(I₁+I₂)−(I₁(0)−I₂(0))/(I₁(0)+I₂(0)) Formula (3)

Here, I₁(0) is the detection intensity of the first pixel when the object is not located. I₂(0) is the detection intensity of the second pixel when the object is not located. The index H of the above formula (3) is also an index which is based on the difference between the detection intensity of the first pixel and the detection intensity of the second pixel.

Instead of creating a function, it is possible to obtain Δx by, for example, converting the relationship between v and Δx into a database and performing interpolation by using data of the database on the basis of v obtained by measurement.

When acquiring an absorption contrast image of the object, it is possible to acquire the absorption contrast image by calculating the sum of I₁ and I₂ and using the sum as the pixel value of the output image. An average value obtained by dividing the sum of I₁ and I₂ by 2 may be used as the pixel value of the output image. The above calculation methods and other calculation methods related to the sum may be referred to as “on the basis of the sum”. Or, data of only I₁ may be used as the pixel value of the output image. Although the center of gravity of the X-ray is located on the boundary between the first pixel and the second pixel in the first embodiment, the center of gravity of the X-ray may be located on other than the boundary between the first pixel and the second pixel if the change of the detection intensity with respect to the change of the intensity of the X-ray incident on the detector is different between the first pixel and the second pixel.

### Second Embodiment

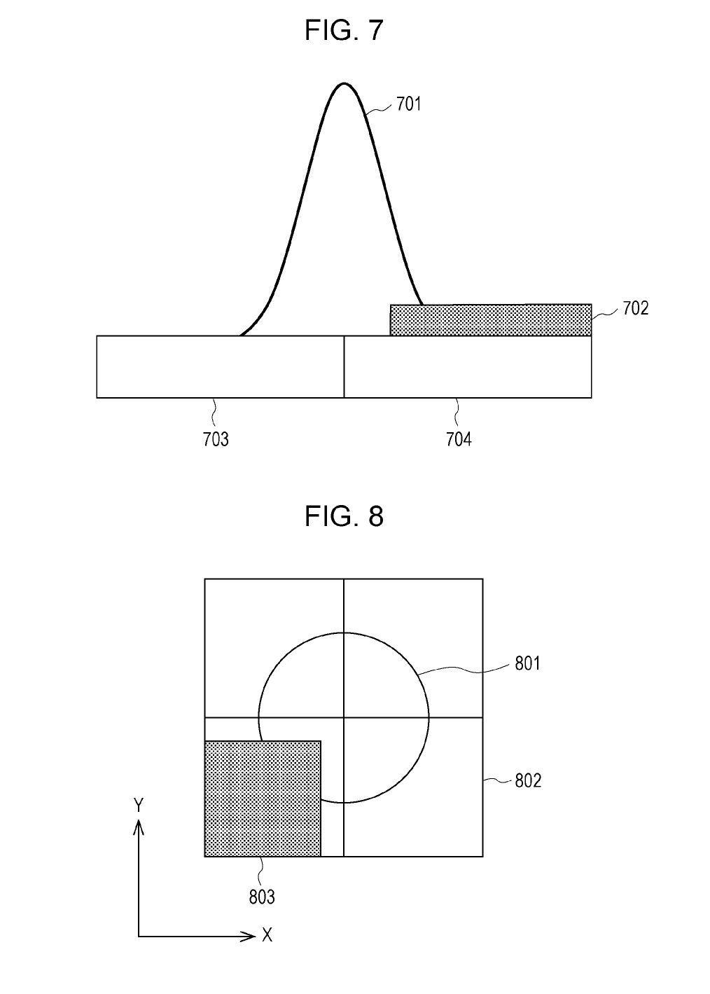

In the present embodiment, an example will be described in which an element that blocks X-ray is used as the attenuation element. Although a device configuration is the same as the configuration described in FIG. 1, the attenuation element 105 and the detector 106 have a configuration shown in FIG. 7.

An X-ray beam 701 is an X-ray beam when an object is not located in the optical path of the X-ray beam. The X-ray beam 701 is irradiated to a first pixel 703 and a second pixel 704. An attenuation element 702 is arranged on the second pixel 704. Here, the center of gravity of the X-ray beam 701 is set to be located on a boundary between the first pixel 703 and the second pixel 704. The attenuation element 702 is arranged on a position different from the boundary between the first pixel 703 and the second pixel 704 and a part of the X-ray beam 701 is blocked. In FIG. 7, the attenuation element 702 is arranged to be in contact with the second pixel 704. However, the attenuation element 702 and the second pixel 704 may be arranged to be apart from each other.

The attenuation element 702 has a function to block the incident X-ray. Therefore, the attenuation element 702 is selected from materials such as Au and W which have a high X-ray absorption ability. The attenuation element 702 need not necessarily have a plate shape as long as the attenuation element 702 has a function to block the X-ray. The attenuation element 702 need not necessarily block all the X-ray, but may block the X-ray at a level at which an image can be acquired. For example, the attenuation element 702 may have a blocking rate of 90% or more.

The change rate of the detection intensity with respect to the position change of the X-ray beam is different between the first pixel 703 and the second pixel 704 due to the attenuation element 702. Therefore, in the same manner as in the first embodiment, it is possible to acquire the scattering information by calculating v, v′, H, or the like by the arithmetic device 107.

As shown in FIG. 8, it is possible to irradiate a boundary portion between four pixels 802 with an X-ray beam 801 and arrange an attenuation element 803 that blocks the X-ray. By this configuration, it is possible to obtain not only the phase information and the scattering information in the X direction, but also the phase information and the scattering information in the Y direction. In other words, the present invention can be applied to three or more pixels.

### Third Embodiment

In the present embodiment, a configuration example of an X-ray device in which a plurality of X-ray beams are generated by using a splitting element will be described.

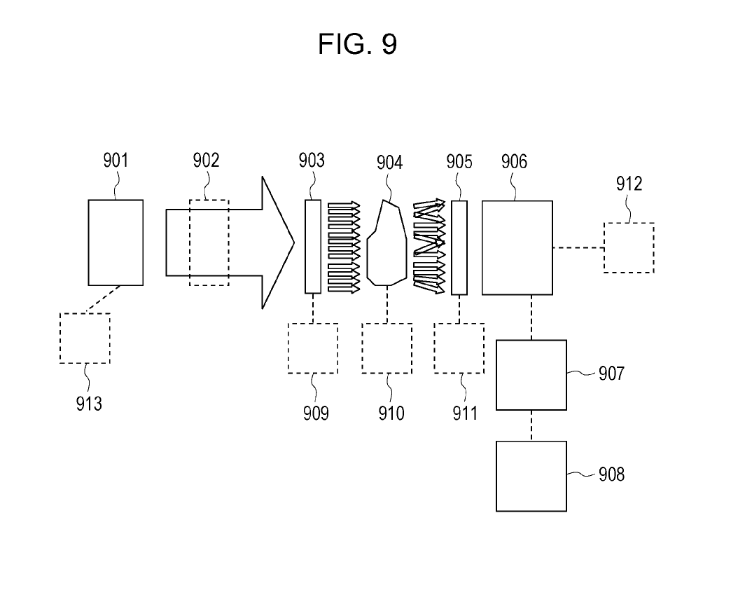

FIG. 9 shows a configuration diagram of the X-ray device according to the present embodiment. An X-ray generated from an X-ray source 901, which is an X-ray generation unit, is divided into line shapes by a splitting element 903. The splitting element 903 is, for example, a slit array including lines and spaces. The splitting element 903 may be a two-dimensional slit which is divided in a direction perpendicular to a period direction of slits or a pin-hole array (in which circular openings are two-dimensionally arranged). When using a pin-hole array, the scattering information of at least two directions can be obtained.

The slits and the pin holes may penetrate a substrate of the splitting element or need not penetrate the substrate. When the slits and the pin holes do not penetrate the substrate, a filter material for X-ray may be used as the substrate of the splitting element. A material that forms the splitting element 903 is selected from Pt, Au, Pb, Ta, W, and the like which have a high absorption rate of X-ray. Or, the material may be a compound including these materials.

The phases of X-ray beams spatially divided by the splitting element 903 are changed by an object 904 and the X-ray beams are refracted. The X-ray is absorbed by the object 904. The intensity profile of the X-ray beam becomes broad due to the effects of the scattering of the X-ray caused by the object 904.

The X-ray beams passing through the object 904 are irradiated to an attenuation element 905 and the intensities of the X-rays are detected by a detector 906. Information related to the X-rays obtained by the detector 906 is arithmetically processed by an arithmetic device 907 and outputted to a display unit 908 such as a monitor.

Moving units 909, 910, 911, 912, and 913 such as stepping motors which relatively move the splitting element 903, the object 904, the attenuation element 905, the detector 906, and the X-ray source 901 may be provided. For example, if the moving unit 910 is provided, the object 904 can be arbitrarily moved, so that an image of a specific portion of the object 904 can be obtained. It is possible to obtain all information of the object 904 by measuring the object 904 while scanning the object with respect to the X-rays, so that high spatial resolution of the output image can be achieved.

It is possible to acquire a CT image by detecting X-ray intensities while rotating the X-ray source 901, the splitting element 903, the attenuation element 905, and the detector 906 in synchronization with each other around the object 904 by using the moving units 909, 911, 912, and 913.

The detector 906 and a monochromatizing unit 902 may be the same as those in the first embodiment.

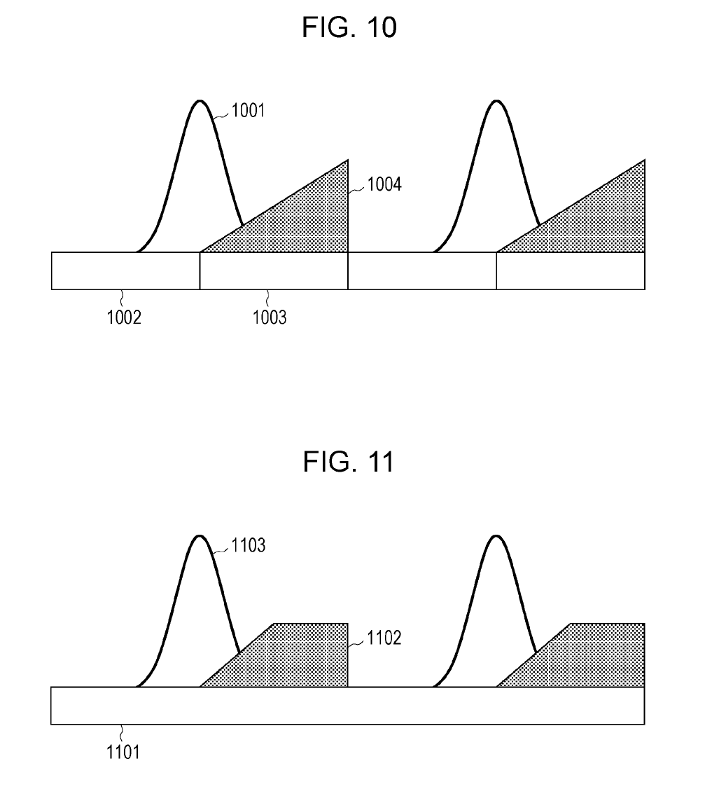

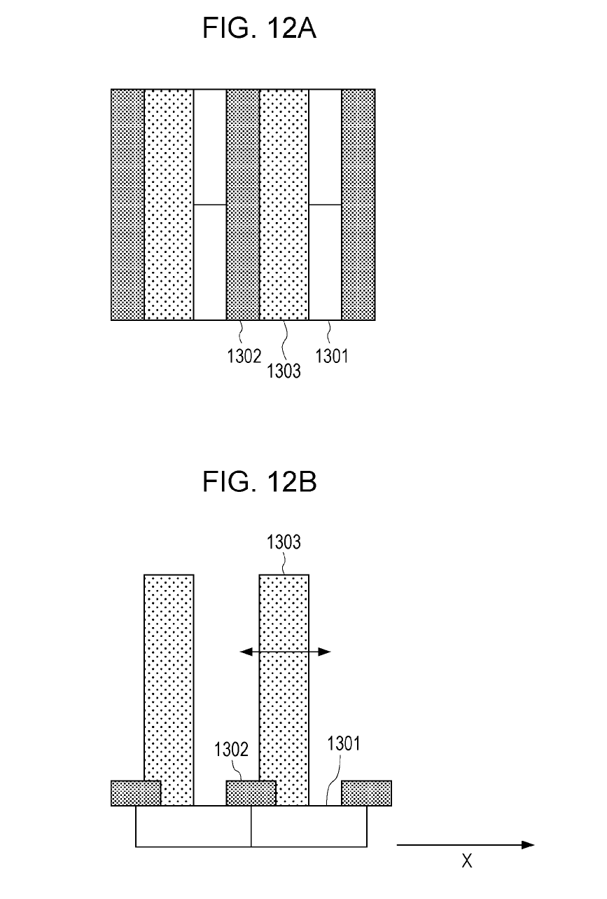

Next, a relationship between the X-ray beams, the attenuation element 905, and the detector 906 according to the present embodiment will be described with reference to FIG. 10. An X-ray beam 1001 is an X-ray beam when the object 904 is not located in the optical path of the X-ray beam. The X-ray beam 1001 is configured to be irradiated to a first pixel 1002 and a second pixel 1003 which is provided with an attenuation element 1004. A plurality of the attenuation elements 1004 are arranged on the detector 906.

For example, the attenuation elements 1004 are arranged every two pixels to be discretely irradiated by considering the pitch of the openings in the splitting element 903, the pixel size of the detector 906, the distance relationships between the X-ray source 901, the splitting element 903, and the detector 906. In FIG. 10, the attenuation element 1004 is arranged to be in contact with the second pixel 1003. However, the attenuation element 1004 and the second pixel 1003 may be arranged to be apart from each other.

For example, when the object 904 is not located in the optical path, the center of gravity of the X-ray beam 1001 on the detector 906 is located on a boundary position between two pixels irradiated with the X-ray beam 1001.

In the same manner as in the above embodiment, it is possible to acquire an image in which the scattering information is superimposed on the phase information by using an arithmetic device 1007 for a plurality of X-ray beams.

### Example

In the present example, an example will be described in which a slit array is used as the splitting element.

The device configuration is the same as that shown in FIG. 9. As the X-ray generation unit 901, a tungsten target rotating anode X-ray generator is used. The splitting element 903 is manufactured by forming a slit array including slits having a width of 50 μm and a pitch of 125 μm in tungsten having a thickness of 50 μm by electrical discharge machining.

An attenuation element 1102 in FIG. 11 is an enlarged attenuation element 905 in FIG. 9. The attenuation element 1102 is manufactured by performing a cutting work on a PMMA substrate 1101 having a thickness of 1 mm on which gold sheet is plated. The vertex angle of the attenuation element is 45°, the thickness of the thickest portion is 50 μm, and the intervals of the attenuation elements are 190 μm.

As the detector 906, an indirect conversion type flat panel detector having a pixel size of 100 μm×100 μm is used.

The splitting element 903 and the attenuation element 905 are moved by using the moving units 909 and 911 to be arranged so that each X-ray beam is projected every two pixels (every 200 μm). The center of gravity of an X-ray beam 1103 is located at the tip portion of the slope portion of the attenuation element 1102. The center of gravity of each X-ray beam is located at a boundary between two pixels irradiated with each X-ray beam.

In this state, v represented by the formula (1) with respect to the amount of position change (Δx) is obtained by measuring the detection intensities of the first pixel and the second pixel of each X-ray beam in the detector 905 while moving the detection element 903. A function to obtain Δx from v can be obtained by fitting the Δx and v by a quartic function.

As the object 904, water and flour, each of which is contained in a plastic container, are used.

The v represented by the formula (1) is calculated by the arithmetic device 907 from intensity data of the first pixel and the second pixel with respect to each X-ray beam and the Δx is obtained by using a quartic function obtained in advance.

An image including the phase information and the scattering information is acquired by arranging Δx of each X-ray beam as values of pixels and the image is outputted to a PC monitor which is a display unit 1107.

As a result of imaging, a difference of contrast is hardly observed between the water and the flour in an image of the absorption contrast. However, a large contrast is obtained in the flour where the scattering is large in the image including the phase information and the scattering information, so that a difference between the water and the flour can be observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-130103, filed Jun. 7, 2012, which is hereby incorporated by reference herein in its entirety.

### REFERENCE SIGNS LIST

101 X-ray source
102 monochromatizing unit
103 aperture
104 object
105 attenuation element

1. An X-ray device comprising:
a detector including a first pixel and a second pixel different from the first pixel, which are configured to detect intensity of an X-ray beam passing through an object;
an attenuation element configured to attenuate an X-ray beam which is a part of the X-ray beam passing through the object and incident on the second pixel; and
an arithmetic device configured to acquire information of the object including scattering information of the object from detection intensity of the X-ray beam detected by the first pixel and detection intensity of the X-ray beam detected by the second pixel,
wherein, when the object is not located in an optical path of the X-ray beam, the X-ray beam is irradiated on a boundary between the first pixel and the second pixel, and
wherein the attenuation element is configured so that an attenuation rate of X-ray changes according to an incident position in the second pixel.

2. The X-ray device according to claim 1, wherein the arithmetic device calculates the information of the object on the basis of an index that can determine a difference between an amount of change of detection intensity of the first pixel and an amount of change of detection intensity of the second pixel.

3. The X-ray device according to claim 2, wherein the index is based on a difference between the detection intensity of the first pixel and the detection intensity of the second pixel or a ratio between the detection intensity of the first pixel and the detection intensity of the second pixel.

4. The X-ray device according to claim 2, wherein the index is acquired from the detection intensity of the first pixel obtained by not locating the object in the optical path of the X-ray beam and the detection intensity of the second pixel obtained by not locating the object in the optical path of the X-ray beam.

5. The X-ray device according to claim 2, wherein the information of the object is calculated on the basis of the index and a function in which a relationship between the index and the object information is fitted.

6. The X-ray device according to claim 2, wherein
the arithmetic device includes a database that indicates a relationship between the index and the information of the object, and
the information of the object is acquired from the database.

7. The X-ray device according to claim 1, wherein the detector includes a plurality of the second pixels, there are the attenuation elements each of which corresponds to each of the plurality of the second pixels, and the attenuation elements each of which corresponds to each of the plurality of the second pixels are separated from one another.

8. The X-ray device according to claim 1, wherein the attenuation element is configured to block a part of the X-ray beam.

9. The X-ray device according to claim 1, wherein the attenuation element is formed of a triangular prism.

10. The X-ray device according to claim 1, wherein the attenuation element is arranged in an optical path of the X-ray beam entering the second pixel and is not arranged in an optical path of the X-ray beam entering the first pixel.

11. The X-ray device according to claim 1, further comprising: a splitting element configured to form a plurality of the X-ray beams.

12. The X-ray device according to claim 11, wherein the splitting element includes a slit array or a pin-hole array.

13. The X-ray device according to claim 1, wherein the arithmetic device calculates information of absorption of the object on the basis of a sum of the detection intensity of the first pixel and the detection intensity of the second pixel.

14. The X-ray device according to claim 1, wherein the first pixel and the second pixel are arranged adjacent to each other.

15. The X-ray device according to claim 1, wherein the information of the object does not include information of X-ray absorbed the object.

16. An X-ray measurement method comprising:
a step of detecting intensity of an X-ray beam passing through an object by a first pixel and a second pixel which detects an X-ray that passes through an attenuation element configured so that an attenuation rate of the X-ray changes according to an incident position of the X-ray beam in the second pixel; and
a step of calculating information of the object including scattering information of the object from detection intensity of the X-ray beam detected by the first pixel and detection intensity of the X-ray beam detected by the second pixel,
wherein, when the object is not located in an optical path of the X-ray beam, the X-ray beam is set to be irradiated on a boundary between the first pixel and the second pixel.

17. The X-ray device according to claim 1, wherein the attenuation element is configured so that the attenuation rate of the X-ray beam increases or decreases according to the incident position in the second pixel.

18. The X-ray device according to claim 3, wherein the index is acquired from the detection intensity of the first pixel obtained by not locating the object in the optical path of the X-ray beam and the detection intensity of the second pixel obtained by not locating the object in the optical path of the X-ray beam.
